(19) United States
(12) Patent Application Publication
(10) Pub. No.: US 2015/0149678 A1
(43) Pub. Date: May 28, 2015

(54) APPARATUS OF HIGH SPEED INTERFACE SYSTEM AND HIGH SPEED INTERFACE SYSTEM

(71) Applicant: ALPHA CHIPS INC., Gyeonggi-do (KR)

(72) Inventor: Ook Kim, Seoul (KR)

(21) Appl. No.: 14/547,656

(22) Filed: Nov. 19, 2014

(30) Foreign Application Priority Data
Nov. 20, 2013 (KR) 10-2013-0141696

(51) Int. Cl. H04L 25/03; G06F 13/40

(52) U.S. Cl. CPC H04L 25/03885; H04L 25/03057; G06F 13/4081
USPC 710/302; 375/232

(57) ABSTRACT

Disclosed are an apparatus (equalizer module or receiving apparatus) of a high speed interface system and a high speed interface system, in which the resistance value of a termination resistor in a circuit for high speed interface is adjusted to follow that of a termination resistor of a sink circuit unit, thereby implementing efficient equalization and high speed interface, and a command bus (CBUS) is not built in an equalizer integrated circuit (IC), so that it is possible to simplify the configuration of the high speed interface system and improve the performance and efficiency of the high speed interface system.

### CROSS-REFERENCE TO RELATED APPLICATIONS

Pursuant to 35 U.S.C. §119(a), this application claims the benefit of earlier filing date and right of priority to Korean Application No. 10-2013-0141696, filed on Nov. 20, 2013, the contents of which is incorporated by reference herein in its entirety.

### BACKGROUND OF THE DISCLOSURE

1. Field of the Disclosure

The present disclosure relates to an apparatus of a high speed interface system and a high speed interface system. Particularly, the present disclosure relates to an apparatus (equalizer module or receiving apparatus) of an high speed interface system and a high speed interface system, in which the resistance value of a termination resistor in a circuit for high speed interface is adjusted to follow that of a termination resistor of a sink circuit unit, so that an efficient, high speed interface can be implemented.

2. Description of the Background Art

Connections between devices in a high speed data interface system are generally made through shielded cables. A cable may cause attenuation of signals due to various factors. As the length of the cable lengthens, the degree of attenuation of signals further increases. Thus, a method will be provided in which, when a user intends to lengthen the length of a cable, the thickness of a copper line used in the cable is thickened so that the attenuation of signals is not excessively increased. However, if the thickness of the cable is thickened, the user has difficulty in dealing with the cable. Therefore, it is a general tendency that the thickness of the cable is to be made as thin as possible. If a thin cable is used, the attenuation of signals is unavoidable. Hence, in order to compensate for the attenuation of signals, a means for compensating for attenuation of signals is generally disposed at transmitting and receiving stages of a high speed data interface system.

FIG. 1 is a circuit diagram illustrating the configuration of a conventional high speed interface system.

As shown in FIG. 1, in the case of a mobile high definition link (MHL), a data driver of an open-drain differential pair type is positioned in a source, and a termination resistor is positioned in a sink connected to the source through a cable. In addition to differential data, a total of six lines including a command bus (CBUS) for bi-directional control, a voltage bus (VBUS) for power transmission and a GND line exist between the source and the sink in the MHL. The CBUS is implemented as a single-ended line formed to transmit and receive only low speed control signals. Although the cable of the CBUS is long, equalization is not generally required. If the source and the sink are connected through cables, a hot plug detection (HPD) operation is performed through the CBUS. The value of Rterm_sink that is a data bus termination resistor in the sink may be changed while the HPD operation is being performed. The Rterm_sink may be in an open-circuit state, or may have a finite resistance value, according to a connection state between the source and the sink and internal operation states of the source and the sink.

If the loss of a cable is large as the length of the cable is long, attenuation of signals is excessive, and therefore, a means for compensating for the attenuation of signals is required. In this case, an equalizer integrated circuit (IC) performs a function of compensating for attenuation of signals. The specification with respect to the loss of the cable is defined by a value measured at both terminals of a connector. If the equalizer IC is disposed inside the sink when the cable is long, there is no effect that decreases the loss measured at both the terminals of the connector. As a result, when the cable is long, the equalizer IC is disposed inside the connector or in the middle of the cable in order to satisfy the specification with respect to the loss of the cable.

Rterm_EQ that is a termination resistor for a differential data bus should be disposed at an input terminal of the equalizer IC. When the equalizer IC does not exist due to the HPD operation through the CBUS, the value of the Rterm_EQ should be adjusted equal to that of the Rterm_sink that is the termination resistor inside the sink. When a CBUS logic is built in the equalizer IC as shown in FIG. 1, the CBUS logic of the equalizer IC adjusts the value of the Rterm_EQ. In this case, the value of the Rterm_sink that is the termination resistor of the sink is also adjusted by a CBUB logic of the sink.

However, if the CBUS logic is built in the equalizer IC, the configuration of the entire system is complicated, and cost for building up the system increases. Since the data transmission speed of the CBUS is very low, the performance and efficiency of the entire system are deteriorated. Since the equalization is not essentially required in the CBUS, the CBUS is hardly built in the equalizer IC.

### SUMMARY OF THE DISCLOSURE

Therefore, an aspect of the detailed description is to provide an apparatus (equalizer module or receiving apparatus) of an high speed interface system and a high speed interface system, in which the resistance value of a termination resistor of an equalizer integrated circuit (IC) can be adjusted to follow that of a termination resistor of a sink circuit unit, without building a CBUS logic in the equalizer IC.

To achieve these and other advantages and in accordance with the purpose of this specification, as embodied and broadly described herein, an equalizer module of a high speed interface system, includes: an input stage provided with a first termination resistor connected to a transmission cable for transmitting a signal, the input stage receiving the signal; an equalizer configured to perform equalization on the received signal; and a resistance adjusting unit connected to a sink circuit unit for receiving the equalized signal from the equalizer and buffering the equalized signal, to detect a reference resistance value that is a resistance value of a second termination resistor provided in the sink circuit unit and adjust the resistance value of the first termination resistor based on the detected reference resistance value.

In one exemplary embodiment, the resistance value of the first termination resistor may be adjusted to follow the reference resistance value.

In one exemplary embodiment, the high speed interface system may be in the form of a differential data bus.

In one exemplary embodiment, the input stage may receive the signal through the transmission cable from a source circuit unit for generating the signal by receiving data to be transmitted.

In one exemplary embodiment, the source circuit unit may include a first differential amplifier in which the input data to be transmitted are amplified.

In one exemplary embodiment, the first differential amplifier may include a pair of first switching elements in the form of a differential pair, and a first bias current source for driving the first switching elements.

In one exemplary embodiment, the input stage may further include a first power unit configured to receive power for driving the equalizer, supplied from the outside.

In one exemplary embodiment, the first power unit may be connected to one end of the first termination resistor, and the other end of the first termination resistor may be connected to the transmission cable and an input terminal of the equalizer.

In one exemplary embodiment, the first and second termination resistors may be a pair of resistors in the form of a differential pair.

In one exemplary embodiment, the equalizer may be provided with a second differential amplifier in which the equalized signal is amplified. The second differential amplifier may be driven by receiving power supplied from a second power unit provided in the sink circuit unit.

In one exemplary embodiment, the second differential amplifier may include a pair of second switching elements in the form of the differential pair; and a second bias current source configured to drive the second switching elements. The second switching element may include a first terminal to which the signal is input; a second terminal to which the second bias current source is connected; and a third terminal to which the signal is amplified and output.

In one exemplary embodiment, the first terminal may be connected to an output terminal of the equalizer, the second terminal may be connected to the second bias current source, and the third terminal may be connected to the resistance adjusting unit and one end of the second termination resistor.

In one exemplary embodiment, the resistance adjusting unit may include a pair of detection resistors configured to detect any one of voltage and current of the sink circuit unit.

In one exemplary embodiment, the resistance adjusting unit may detect any one of voltage and current of the sink circuit unit using any one method of current calculation and voltage distribution between the detection resistor and the second termination resistor. The resistance adjusting unit may detect the resistance value of the second termination resistor, based on any one of the detected voltage and current.

In one exemplary embodiment, the resistance adjusting unit may be connected to one end of the detection resistor and the one end of the second termination resistor.

In one exemplary embodiment, the high speed interface system may further include a command bus (CBUS) to which hot plug detection (HPD) information on the sink circuit unit is transmitted.

In one exemplary embodiment, the sink circuit unit may include a CBUS logic circuit configured to perform an HPD function.

In one exemplary embodiment, the CBUS logic circuit may adjust the resistance value of the second termination resistor.

To achieve these and other advantages and in accordance with the purpose of this specification, as embodied and broadly described herein, a receiving apparatus of a high speed interface system, includes: an input stage provided with a first termination resistor connected to a transmission cable for transmitting a signal, the input stage receiving the signal; an equalizer configured to perform equalization on the received signal; a sink circuit unit provided with a second termination resistor, the sink circuit unit receiving the equalized signal from the equalizer and buffering the equalized signal; and a resistance adjusting unit configured to detect a reference resistance value that is a resistance value of a second termination resistor provided in the sink circuit unit and adjust the resistance value of the first termination resistor based on the detected reference resistance value.

In one exemplary embodiment, the resistance value of the first termination resistor may be adjusted to follow the reference resistance value.

In one exemplary embodiment, the high speed interface system may be in the form of a differential data bus.

In one exemplary embodiment, the input stage may receive the signal through the transmission cable from a source circuit unit for generating the signal by receiving data to be transmitted.

In one exemplary embodiment, the source circuit unit may include a first differential amplifier in which the input data to be transmitted are amplified.

In one exemplary embodiment, the first differential amplifier may include a pair of first switching elements in the form of a differential pair, and a first bias current source for driving the first switching elements.

In one exemplary embodiment, the input stage may further include a first power unit configured to receive power for driving the equalizer, supplied from the outside.

In one exemplary embodiment, the first power unit may be connected to one end of the first termination resistor, and the other end of the first termination resistor may be connected to the transmission cable and an input terminal of the equalizer.

In one exemplary embodiment, the first and second termination resistors may be a pair of resistors in the form of a differential pair.

In one exemplary embodiment, the sink circuit unit may be provided with a second differential amplifier in which the equalized signal is amplified, and a second power unit for receiving power for driving the second differential amplifier, supplied from the outside.

In one exemplary embodiment, the second differential amplifier may include a pair of second switching elements in the form of the differential pair; and a second bias current source configured to drive the second switching elements. The second switching element may include a first terminal to which the signal is input; a second terminal to which the second bias current source is connected; and a third terminal to which the signal is amplified and output.

In one exemplary embodiment, the first terminal may be connected to an output terminal of the equalizer, the second terminal may be connected to the second bias current source, and the third terminal may be connected to the resistance adjusting unit and one end of the second termination resistor. The second power unit may be connected to the other end of the second termination resistor.

In one exemplary embodiment, the resistance adjusting unit may include a pair of detection resistors configured to detect any one of voltage and current of the sink circuit unit.

In one exemplary embodiment, the resistance adjusting unit may detect any one of voltage and current of the sink circuit unit using any one method of current calculation and voltage distribution between the detection resistor and the second termination resistor. The resistance adjusting unit may detect the resistance value of the second termination resistor, based on any one of the detected voltage and current.

In one exemplary embodiment, the resistance adjusting unit may be connected to one end of the detection resistor and the one end of the second termination resistor.

In one exemplary embodiment, the high speed interface system may further include a CBUS to which HPD information on the sink circuit unit is transmitted.

In one exemplary embodiment, the sink circuit unit may include a CBUS logic circuit configured to perform an HPD function.

In one exemplary embodiment, the CBUS logic circuit may adjust the resistance value of the second termination resistor.

To achieve these and other advantages and in accordance with the purpose of this specification, as embodied and broadly described herein, a high speed interface system includes: a transmitting apparatus configured to transmit a signal to be transmitted; and a receiving apparatus configured to receive the signal, wherein the transmitting apparatus includes: a source circuit unit configured to generate the signal by receiving data to be transmitted; and a transmitting unit configured to transmit the signal from the source circuit unit to the receiving apparatus, and wherein the receiving apparatus includes: an input unit provided with a first termination resistor connected to the transmitting unit, the input unit receiving the signal; an equalizer configured to perform equalization on the received signal; a sink circuit unit provided with a second termination resistor, the sink circuit unit receiving the equalized signal from the equalizer and buffering the equalized signal; and a resistance adjusting unit configured to detect a reference resistance value that is a resistance value of the second termination resistor and adjust the resistance value of the first termination resistor based on the detected reference resistance value.

In one exemplary embodiment, the resistance value of the first termination resistor may be adjusted to follow the reference resistance value.

In one exemplary embodiment, the high speed interface system may be in the form of a differential data bus, and the first and second termination resistors may be a pair of resistors in the form of a differential pair.

In one exemplary embodiment, the source circuit unit may include a first differential amplifier in which the input data to be transmitted are amplified.

In one exemplary embodiment, the first differential amplifier may include a pair of first switching elements in the form of a differential pair, and a first bias current source for driving the first switching elements.

In one exemplary embodiment, the input unit may further include a first power unit configured to receive power for driving the equalizer, supplied from the outside.

In one exemplary embodiment, the first power unit may be connected to one end of the first termination resistor, and the other end of the first termination resistor may be connected to the transmission cable and an input terminal of the equalizer.

In one exemplary embodiment, the sink circuit unit may be provided with a second differential amplifier in which the equalized signal is amplified, and a second power unit for receiving power for driving the second differential amplifier, supplied from the outside.

In one exemplary embodiment, the second differential amplifier may include a pair of second switching elements in the form of the differential pair; and a second bias current source configured to drive the second switching elements. The second switching element may include a first terminal to which the signal is input; a second terminal to which the second bias current source is connected; and a third terminal to which the signal is amplified and output.

In one exemplary embodiment, the first terminal may be connected to an output terminal of the equalizer, the second terminal may be connected to the second bias current source, and the third terminal may be connected to the resistance adjusting unit and one end of the second termination resistor. The second power unit may be connected to the other end of the second termination resistor.

In one exemplary embodiment, the resistance adjusting unit may include a pair of detection resistors configured to detect any one of voltage and current of the sink circuit unit.

In one exemplary embodiment, the resistance adjusting unit may detect any one of voltage and current of the sink circuit unit using any one method of current calculation and voltage distribution between the detection resistor and the second termination resistor. The resistance adjusting unit may detect the resistance value of the second termination resistor, based on any one of the detected voltage and current.

In one exemplary embodiment, the resistance adjusting unit may be connected to one end of the detection resistor and the one end of the second termination resistor.

In one exemplary embodiment, the high speed interface system may further include a CBUS to which HPD information on the sink circuit unit is transmitted.

In one exemplary embodiment, the sink circuit unit may include a CBUS logic circuit configured to perform an HPD function.

In one exemplary embodiment, the CBUS logic circuit may adjust the resistance value of the second termination resistor.

To achieve these and other advantages and in accordance with the purpose of this specification, as embodied and broadly described herein, a high speed interface system includes: a transmitting apparatus configured to generate a signal by receiving data to be transmitted; a transmitting unit configured to transmit the signal from the transmitting apparatus to a receiving apparatus; and the receiving apparatus configured to receive the signal, wherein the receiving apparatus includes: an input unit provided with a first termination resistor connected to the transmitting unit, the input unit receiving the signal; an equalizer configured to perform equalization on the received signal; a sink circuit unit provided with a second termination resistor, the sink circuit unit receiving the equalized signal from the equalizer and buffering the equalized signal; and a resistance adjusting unit configured to detect a reference resistance value that is a resistance value of the second termination resistor and adjust the resistance value of the first termination resistor based on the detected reference resistance value.

In one exemplary embodiment, the resistance value of the first termination resistor may be adjusted to follow the reference resistance value.

In one exemplary embodiment, the high speed interface system may be in the form of a differential data bus, and the first and second termination resistors may be a pair of resistors in the form of a differential pair.

In one exemplary embodiment, the source circuit unit may include a first differential amplifier in which the input data to be transmitted are amplified.

In one exemplary embodiment, the first differential amplifier may include a pair of first switching elements in the form of a differential pair, and a first bias current source for driving the first switching elements.

In one exemplary embodiment, the input unit may further include a first power unit configured to receive power for driving the equalizer, supplied from the outside.

In one exemplary embodiment, the first power unit may be connected to one end of the first termination resistor, and the other end of the first termination resistor may be connected to the transmission cable and an input terminal of the equalizer.

In one exemplary embodiment, the sink circuit unit may be provided with a second differential amplifier in which the equalized signal is amplified, and a second power unit for receiving power for driving the second differential amplifier, supplied from the outside.

In one exemplary embodiment, the second differential amplifier may include a pair of second switching elements in the form of the differential pair; and a second bias current source configured to drive the second switching elements. The second switching element may include a first terminal to which the signal is input; a second terminal to which the second bias current source is connected; and a third terminal to which the signal is amplified and output.

In one exemplary embodiment, the first terminal may be connected to an output terminal of the equalizer, the second terminal may be connected to the second bias current source, and the third terminal may be connected to the resistance adjusting unit and one end of the second termination resistor. The second power unit may be connected to the other end of the second termination resistor.

In one exemplary embodiment, the resistance adjusting unit may include a pair of detection resistors configured to detect any one of voltage and current of the sink circuit unit.

In one exemplary embodiment, the resistance adjusting unit may detect any one of voltage and current of the sink circuit unit using any one method of current calculation and voltage distribution between the detection resistor and the second termination resistor. The resistance adjusting unit may detect the resistance value of the second termination resistor, based on any one of the detected voltage and current.

In one exemplary embodiment, the resistance adjusting unit may be connected to one end of the detection resistor and the one end of the second termination resistor.

In one exemplary embodiment, the high speed interface system may further include a CBUS to which HPD information on the sink circuit unit is transmitted.

In one exemplary embodiment, the sink circuit unit may include a CBUS logic circuit configured to perform an HPD function.

In one exemplary embodiment, the CBUS logic circuit may adjust the resistance value of the second termination resistor.

In the apparatus of the high speed interface system and the high speed interface system according to the present disclosure, the resistance value of a termination resistor in a circuit for high speed interface is adjusted to follow that of the termination resistor of the sink circuit unit, so that it is possible to implement efficient equalization and high speed interface.

In the apparatus of the high speed interface system and the high speed interface system according to the present disclosure, the CBUS is not built in the equalizer IC, so that the configuration of the high speed interface system can be simplified.

In the apparatus of the high speed interface system and the high speed interface system according to the present disclosure, the resistance value of the termination resistor is adjusted without building the CBUS in the equalizer IC, so that it is possible to improve the performance and efficiency of the high speed interface system.

In the apparatus of the high speed interface system and the high speed interface system according to the present disclosure, efficient equalization is implemented while simplifying the configuration of the high speed interface system, so that the thickness of a data transmission cable can be maintained thin.

In the apparatus of the high speed interface system and the high speed interface system according to the present disclosure, the thickness of the data transmission cable is maintained thin, so that it is possible to suppress loss and attenuation of signals.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a circuit diagram illustrating the configuration of a conventional high speed interface system;

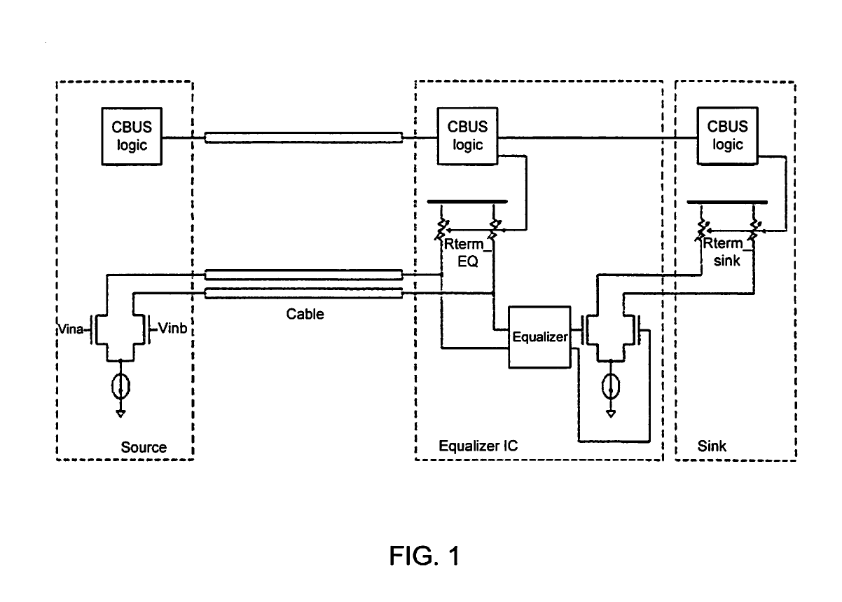

FIG. 2 is a configuration diagram illustrating an equalizer module of a high speed interface system according to the present disclosure;

FIG. 3 is a circuit configuration diagram illustrating an exemplary embodiment of the equalizer module of the high speed interface system according to the present disclosure;

FIG. 4 is a circuit configuration diagram illustrating another exemplary embodiment of the equalizer module of the high speed interface system according to the present disclosure;

FIG. 5 is a configuration diagram illustrating a receiving apparatus of the high speed interface system according to the present disclosure;

FIG. 6 is a circuit configuration diagram illustrating an exemplary embodiment of the receiving apparatus of the high speed interface system according to the present disclosure;

FIG. 7 is a circuit configuration diagram illustrating another exemplary embodiment of the receiving apparatus of the high speed interface system according to the present disclosure;

FIG. 8 is a configuration diagram illustrating the high speed interface system according to the present disclosure; and

FIG. 9 is a circuit configuration diagram illustrating an exemplary embodiment of the high speed interface system according to the present disclosure.

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

The technique according to the present disclosure may be applied to an apparatus of a high speed interface system and a high speed interface system. However, the technique disclosed in the present disclosure is not limited thereto, and may be applied to all interface apparatuses and systems, e.g., a data transmission cable, a mobile high definition link (MHL), a digital visual interface (DVI), a high definition multimedia interface (HDMI), and the like.

### <Equalizer Module>

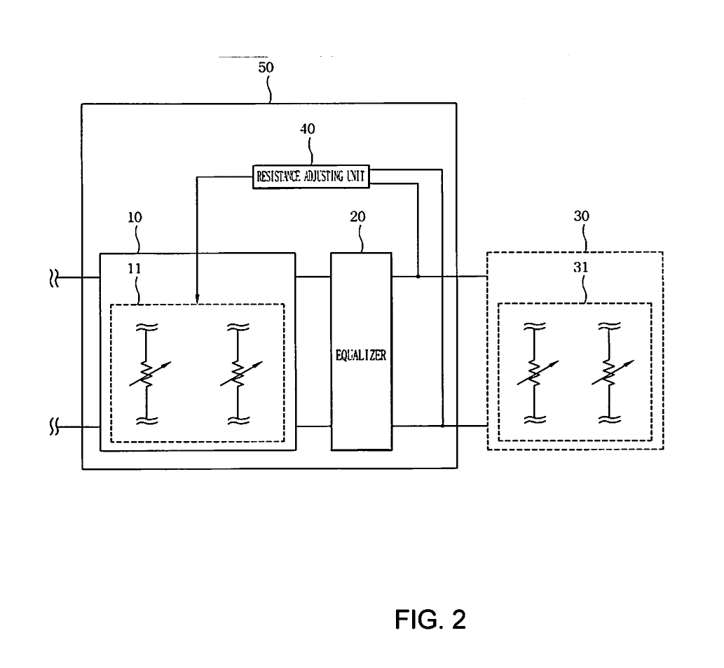

Hereinafter, exemplary embodiments of an equalizer module of a high speed interface system according to the present disclosure will be described with reference to FIGS. 2 to 4.

FIG. 2 is a configuration diagram illustrating an equalizer module of a high speed interface system according to the present disclosure.

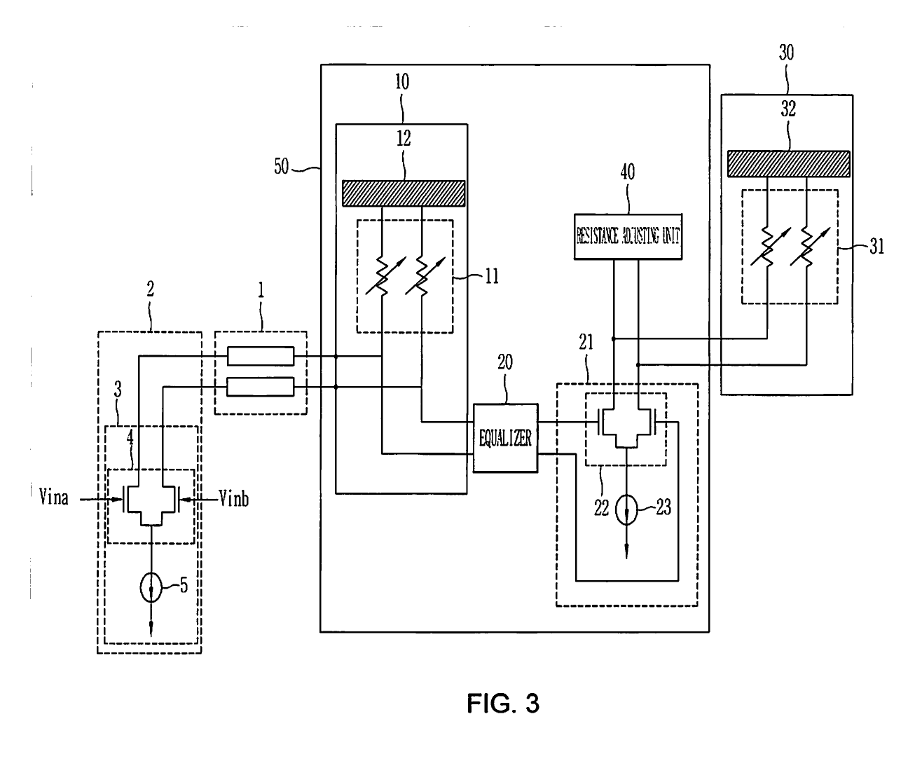

FIG. 3 is a circuit configuration diagram illustrating an exemplary embodiment of the equalizer module of the high speed interface system according to the present disclosure.

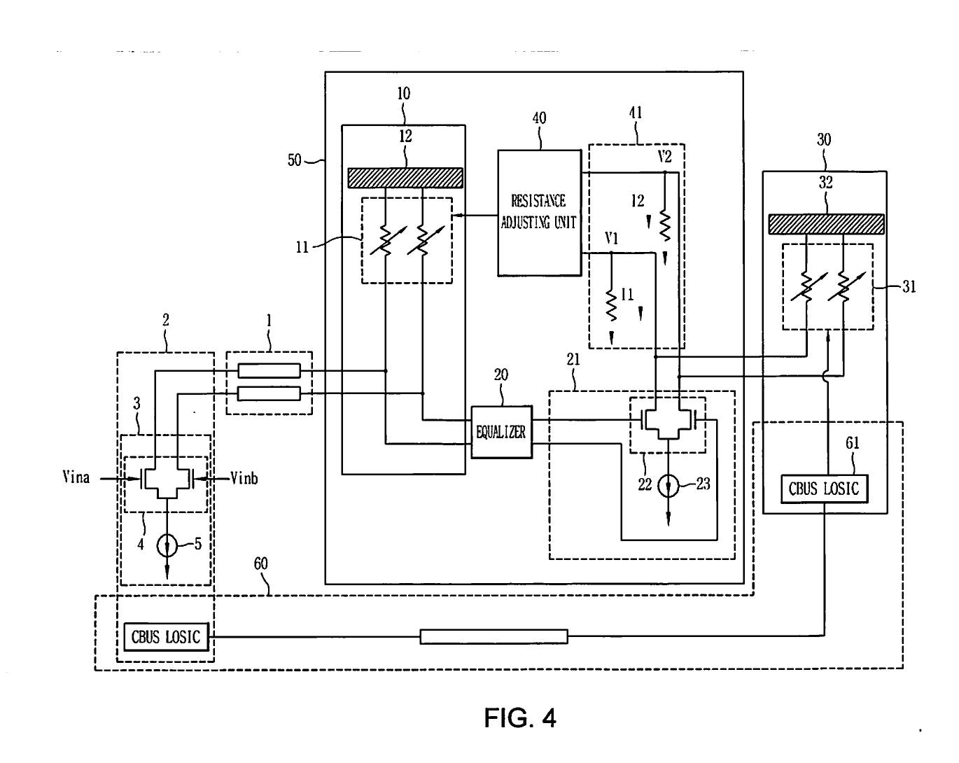

FIG. 4 is a circuit configuration diagram illustrating another exemplary embodiment of the equalizer module of the high speed interface system according to the present disclosure.

First, the configuration of an equalizer module of a high speed interface system (hereinafter, referred to as an equalizer module) will be described with reference to FIG. 2.

As shown in FIG. 2, the equalizer module 50 includes an input stage 10 provided with a first termination resistor 11 connected to a transmission cable for transmitting a signal, the input stage 10 receiving the signal; an equalizer 20 for performing equalization on the received signal; and a resistance adjusting unit 40 connected to a sink circuit unit 30 for receiving the equalized signal and buffering the equalized signal, to detect a reference resistance value that is a resistance value of a second termination resistor 31 provided in the sink circuit unit 30 and adjust the resistance value of the first termination resistor 11 based on the detected reference resistance value.

The equalizer module 50 may be in the form of an integrated circuit (IC) in which a plurality of circuit elements are integrated on or in a substrate to perform a specific function.

The plurality of circuit elements mean all circuit elements that constitute an electronic circuit, such as resistors, capacitors, inductors, diodes, transistors and semiconductor elements.

The equalizer module 50 according to the present disclosure means, in the form such as the IC, an equalizer IC for performing equalization on a received signal.

The equalization means that the frequency of a received signal is adjusted. For example, the equalization may mean that the form of a signal transmitted on a circuit or cable is returned to that of the original signal by compensating for attenuation of the transmitted signal. In this case, an equalizer performs such a function.

The equalizer 20 according to the present disclosure means an equalizer for performing the equalization.

The equalizer module 50 is an IC included any one high speed interface apparatus or system, and may perform the equalization in the high speed interface apparatus or system.

For example, the equalizer module 50 may be included in a gender, a connector, a cable port and the like, which enable signal communication between heterogeneous or homogeneous devices, to perform the equalization on a received signal.

Alternatively, the equalizer module 50 may be included in a signal receiving unit or central processing unit in a device, to perform the equalization on a signal received in the device.

In the equalizer module 50, the first and second termination resistors 11 and 31 mean termination resistors for suppressing the reflected wave of the signal.

In the equalizer module 50, the first and second termination resistors 11 and 31 may be variable resistors of which resistance values can be adjusted.

In the equalizer module 50, the resistance value of the first termination resistor 11 may be adjusted to follow the reference resistance value.

For example, when the reference resistance value is 100Ω, the resistance value of the first termination resistor 11 may be adjusted to become 100Ω.

If the resistance value of the first termination resistor 11 is adjusted to follow the reference resistance value, impedances of both the ends of a line through which the signal is transmitted/received become equal to each other, so that the attenuation and reflection of the signal are reduced.

That is, that the resistance value of the first termination resistor 11 is adjusted to follow the reference resistance value means impedance matching in which impedances of both the ends of a line are equal to each other.

The equalizer module 50 performs the impedance matching between the first and second termination resistors 11 and 31.

The high speed interface system may be in the form of a differential data bus.

The differential data bus means a data transmission technique in which a signal is transmitted together in the form of a reverse signal and a non-reversed signal through two or more lines.

That is, the high speed interface system simultaneously transmits a reversed signal and a non-reversed signal.

If a differential value between the reversed signal and the non-reversed signal, received to the differential data bus, is obtained, a signal from which noise and offset included during transmission are removed can be obtained.

The high speed interface system is in the form of the differential data bus, so that the signal can be received in the form where noise and offset are removed therefrom.

The transmission cable means a line that is made of a material having conductivity, e.g., a material such as copper (Cu), so that data and signals can be transmitted therethrough.

The transmission cable may be in the form of the differential data bus. The transmission cable may be configured with a line through which the reversed signal is transmitted and a line through which the non-reversed signal is transmitted.

That is, the transmission cable may be configured with at least two lines.

The transmission cable may be in the form of one cable including a plurality of lines, or may be in the form of a plurality of cables corresponding to the respective lines.

The transmission cable may further include a VBUS for supplying power to the equalizer module 50 and a GND line.

When the VBUS and the GND line are further included in the transmission cable, the transmission cable may be configured with at least four lines.

The sink circuit unit 30 means a circuit unit to which the signal received from the equalizer module 50 is output.

The signal may be output in the form where the signal is transmitted to another device or where the output of the signal is displayed in a series of devices.

Hereinafter, the configuration of an exemplary embodiment of the equalizer module of the high speed interface system according to the present disclosure will be described with reference to FIG. 3.

As shown in FIG. 3, the equalizer module 50 includes the input stage 10 provided with the termination resistor 11 connected to a transmission cable 1 for transmitting a signal, the input stage 10 receiving the signal; the equalizer for performing equalization on the received signal; and the resistance adjusting unit 40 connected to the sink circuit unit 30 for receiving the equalized signal and buffering the equalized signal, to detect the reference resistance value that is a resistance value of the second termination resistor 31 and adjust the resistance value of the first termination resistor 11 based on the detected reference resistance value. The input stage 10 may receive the signal through the transmission cable 1 from a source circuit unit 2 for generating the signal by receiving data to be transmitted.

The source circuit unit 2 may generate the signal by receiving the data to be transmitted from another device connected thereto, and transmit the generated signal to the equalizer module 50 through the transmission cable 1.

The connected device, for example, may be an electronic device connected to a heterogeneous or homogeneous device, such as a mobile terminal, camera, printer, scanner, tablet PC, notebook computer, TV, monitor or screen.

The source circuit unit 2 may include a first differential amplifier 3 in which the input data to be transmitted are amplified.

The input data to be transmitted are amplifier through the first differential amplifier 3, so that the signal can be transmitted to the input stage 10 of the equalizer module 50.

The first differential amplifier 3 may include a pair of first switching elements 4 in the form of a differential pair, and a first bias current source 5 for driving the first switching elements 4.

The first switching element 4 may be a transistor as a semiconductor element for amplifying a signal input thereto.

The first switching element 4 may be any one of a bipolar junction transistor (BJT) and a field effect transistor (FET).

The first bias current source 5, as an independent current source, may supply current to an emitter or source terminal of the first switching element 4 so that the first switching element 4 can be driven.

The input stage 10 may further include a first power unit 12 that receives power for driving the equalizer 20, supplied from the outside.

That is, the first power unit 12 receives bias power of the equalizer 20, supplied from the outside, to supply the received bias power to the equalizer 20, so that the equalizer 20 can be driven.

The first power unit 12 may also receive the bias power of the equalizer 20, supplied from the VBUS.

The first power unit 12 may be connected to one end of the first termination resistor 11, and the other end of the first termination resistor 11 may be connected to the transmission cable 1 and an input terminal of the equalizer 20.

The first and second termination resistors 11 and 31 may be a pair of resistors in the form of a differential pair.

The high speed interface system is in the form of the differential data bus, so that the first and second termination resistors 11 and 31 can be in the form of the differential pair.

That is, any one of the pair of resistors is connected to the line through which the reversed signal is transmitted in the transmission cable 1, and the other of the pair of the resistors is connected to the line through which the non-reversed signal is transmitted in the transmission cable 1.

The equalizer 20 is provided with a second differential amplifier 21 in which the equalized signal is amplified, and the second differential amplifier 21 may be driven by receiving power supplied from a second power unit 32 provided in the sink circuit unit 30.

That is, the second power unit 32 receives bias power of the second differential amplifier 21, supplied from the outside, to supply the received the bias power to the second differential amplifier 21, so that the second differential amplifier 21 can be driven.

The second power unit 32 may also receive the bias power of the second differential amplifier 21 from the VBUS.

The second differential amplifier 21 includes a pair of second switching elements 22 in the form of a differential pair, and a second bias current source 23 for driving the second switching elements 22. The second switching element 22 may have a first terminal to which the signal is input, a second terminal connected to the second bias current source 23, and a third terminal to which the signal is amplified and output.

The second differential amplifier 21 is configured with the pair of second switching elements 22 in the form of the differential pair. That is, any one of the pair of second switching elements 22 is connected to the line through which the reversed signal is transmitted, and the other of the pair of second switching elements 22 is connected to the line through which the non-reversed signal is transmitted.

The second switching element 22 may be any one of a BJT and an FET as a semiconductor element for amplifying a signal input thereto.

When the second switching element 22 is the BJT, the first, second and third terminals may be base, emitter and collector terminals, respectively.

When the second switching element 22 is the FET, the first, second and third terminals may be gate, source and drain terminals, respectively.

The second bias current source 23, as an independent current source, may supply current to the emitter or source terminal of the second switching element 22 so that the second switching element 22 can be driven.

The first terminal may be connected to an output terminal of the equalizer 20, and the second terminal may be connected to the second bias current source 23. The third terminal may be connected to the resistance adjusting unit 40 and one end of the second termination resistor 31.

That is, the equalized signal output from the equalizer 20 is input the first terminal of the second switching element 22, and the second switching element 22 is driven by the second bias current source 23 connected to the second terminal of the second switching element 22, so that the amplified signal is output from the third terminal of the second switching element 22 to be transmitted to the second termination resistor 31.

The signal amplified in the second differential amplifier 21 and transmitted to the second termination resistor 31 may be output in the form where the signal is transmitted to another device from the sink circuit unit 30 or where the output of the signal is displayed in a series of devices.

For example, the series of devices may be devices in which the output of the signal can be displayed in the form of an audio or video, such as a mobile terminal, a camera, a printer, a tablet PC, a notebook computer, a TV, a monitor and a screen.

The resistance adjusting unit 40 detects the reference resistance value that is a resistance value of the second termination resistor 31 and adjusts the resistance value of the first termination resistor 11 based on the detected reference resistance value.

Hereinafter, another exemplary embodiment of the equalizer module of the high speed interface system according to the present disclosure will be described with reference to FIG. 4.

As shown in FIG. 4, the equalizer module 50 includes the input stage 10 provided with the termination resistor 11 connected to the transmission cable 1 for transmitting a signal, the input stage 10 receiving the signal; the equalizer for performing equalization on the received signal; and the resistance adjusting unit 40 connected to the sink circuit unit 30 for receiving the equalized signal and buffering the equalized signal, to detect the reference resistance value that is a resistance value of the second termination resistor 31 and adjust the resistance value of the first termination resistor 11 based on the detected reference resistance value. The resistance adjusting unit 40 may include a pair of detection resistors 41 for detecting any one of voltage and current of the sink circuit unit 30.

One end of the detection resistor 41 is connected to one end of the second termination resistor 31, and the other end of the detection resistor 41 is connected to the GND line, so that the detection resistor 41 can be connected in series to the second termination resistor 31.

The resistance adjusting unit 40 detects any one of voltage and current of the sink circuit unit 30 using any one method of current calculation and voltage distribution between the detection resistor 40 and the second termination resistor 31. In this case, the resistance adjusting unit 40 may detect the resistance value of the second termination resistor 31, based on any one of the detected voltage and current.

This will be described with reference to FIG. 4. The voltages V1 and V2 shown in the detection resistors 41 of FIG. 4 may be changed depending on a ratio of resistance values of the second termination resistor 31 and the detection resistor 41. Therefore, if the voltages V1 and V2 are measured, the reference resistance value that is the resistance value of the second termination resistor 31 may be detected using an equation with respect to the voltage distribution.

The equation with respect to the voltage distribution may be represented by the following Equation 1.

$$V = \frac{{R}_{sense}}{{R}_{sense} + {R}_{sin k}} {V}_{term} \qquad Equation 1$$

Here, V denotes the value of a voltage detected from V1 or V2, Rₛₑₙₛₑ denotes the resistance value of the detection resistor 41, Rₛᵢₙₖ denotes the reference resistance value, and Vₜₑᵣₘ denotes the value of a voltage supplied from the second power unit 32.

In the circuit shown in FIG. 4, if the driving of the second switching element 22 is off as the second bias current source 23 of the second differential amplifier 21 is off, the circuit up to the second differential amplifier 21 is in an open-circuit state, so that the voltage distribution represented by Equation 1 occurs between the detection resistor 41 and the second termination resistor 31.

If Equation 1 is changed into an equation with respect to the reference resistance value, the equation may be represented by the following Equation 2.

$${R}_{sin k} = \frac{( {V}_{term} - V )}{V} {R}_{sense} \qquad Equation 2$$

The resistance adjusting unit 40, through the equation such as Equation 2, may detect the resistance value of the second termination resistor 31 based on the detected voltage V1 or V2 detected from the detection resistor 41.

The resistance adjusting unit 40 may also detect the resistance value of the second termination resistor 31 using the method of current calculation.

This will be described with reference to FIG. 4. The currents I1 and I2 shown in the detection resistors 41 of FIG. 4 are determined as a composite resistance value obtained by adding up the resistance values of the second termination resistor 31 and the detection resistor 41. Therefore, if the currents I1 and I2 are measured, the reference resistance value that is the resistance value of the second termination resistor 31 may be detected using an equation with respect to the current calculation.

The equation with respect to the current calculation may be represented by the following Equation 3.

$$I = \frac{{V}_{term}}{{R}_{sense} + {R}_{sin k}} \qquad Equation 3$$

Here, I denotes the value of current detected from I1 or I2.

In the circuit shown in FIG. 4, if the driving of the second switching element 22 is off as the second bias current source 23 of the second differential amplifier 21 is off, the circuit up to the second differential amplifier 21 is in the open-circuit state, so that the current represented by Equation 3 flows between the detection resistor 41 and the second termination resistor 31.

If Equation 3 is changed into an equation with respect to the reference resistance value, the equation may be represented by the following Equation 4.

$${R}_{sin k} = \frac{( {V}_{term} - {IR}_{sense} )}{I} \qquad Equation 4$$

The resistance adjusting unit 40, through the equation such as Equation 4, may detect the resistance value of the second termination resistor 31 based on the current I1 or I2 detected from the detection resistor 41.

The resistance adjusting unit 40 adjusts the resistance value of the first termination resistor 11 to follow the detected reference resistance value, based on the detected reference resistance value.

The resistance adjusting unit 40 may be connected to one end of the detection resistor 41 and one end of the second termination resistor 31.

That is, the detection resistor 41 and the second termination resistor 31 are branched from the resistance adjusting unit 40 to be connected to the resistance adjusting unit 40.

The high speed interface system may further include a command bus (CBUS) 60 to which hot plug detection (HPD) information on the sink circuit unit 30 is transmitted.

The HPD information means a function of identifying whether the device to which the signal is to be output is to be connected to the sink circuit unit 30

The CBUS 60 may be configured with a single-ended line through which the HPD information is transmitted. In this case, a low speed control signal may be transmitted/received through the CBUS 60.

That is, the CBUS 60 is separately provided with a line through which the control signal is received and a line through which the control signal is transmitted. Therefore, the CBUS 60 may be configured with at least two lines.

The CBUS 60 may be included in the transmission cable 1, or may be separated as a separate line.

When the CBUS 60 is included in the transmission cable 1, the transmission cable 1 may be configured with at least six lines, including at least two lines in the form of the differential data bus, a voltage bus (VBUS) for supplying power to the equalizer module 50, a GND line, and at least two control lines of the CBUS 60.

The HPD information may be transmitted to the device to which the signal is input through the CBUS 60.

The sink circuit unit 30 may include a CBUS logic circuit 61 for performing an HPD function.

The CBUS logic circuit 61 may also be included in a circuit in which the signal is generated.

The CBUS logic circuit 61 may adjust the resistance value of the second termination resistor 31.

The CBUS logic circuit 61 may adjust the resistance value of the second termination resistor 31 depending on a kind of device connected to the sink circuit unit 30, a form and state of the signal, a state of the transmission cable 1, a state of the equalizer module 50, and the like.

The CBUS logic circuit 61 adjusts the resistance value of the second termination resistor 30, so that the resistance value matching with the first termination resistor 11 can be implemented in the second termination resistor 31.

### <Receiving Apparatus>

A receiving apparatus according to the present disclosure may be implemented using a portion or combination of components or steps included in exemplary embodiments described above and to be described later, or may be implemented using a combination of the exemplary embodiments. The technical terms used herein are used only for the purpose of illustrating a specific exemplary embodiment and do not limit the technical spirit of the present disclosure.

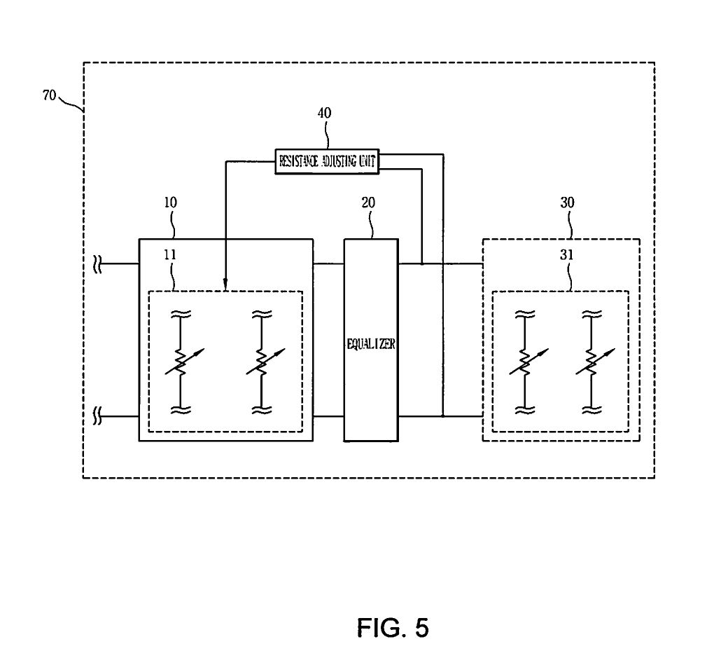

Hereinafter, exemplary embodiments of the receiving apparatus of the high speed interface system will be described with reference to FIGS. 5 to 7.

FIG. 5 is a configuration diagram illustrating a receiving apparatus of the high speed interface system according to the present disclosure.

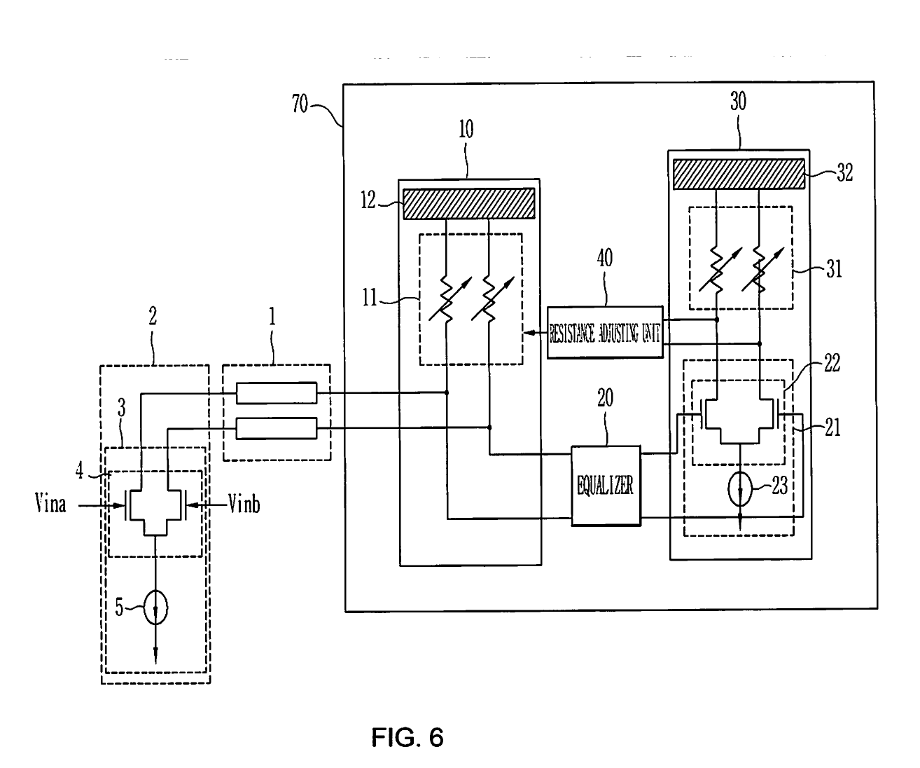

FIG. 6 is a circuit configuration diagram illustrating an exemplary embodiment of the receiving apparatus of the high speed interface system according to the present disclosure.

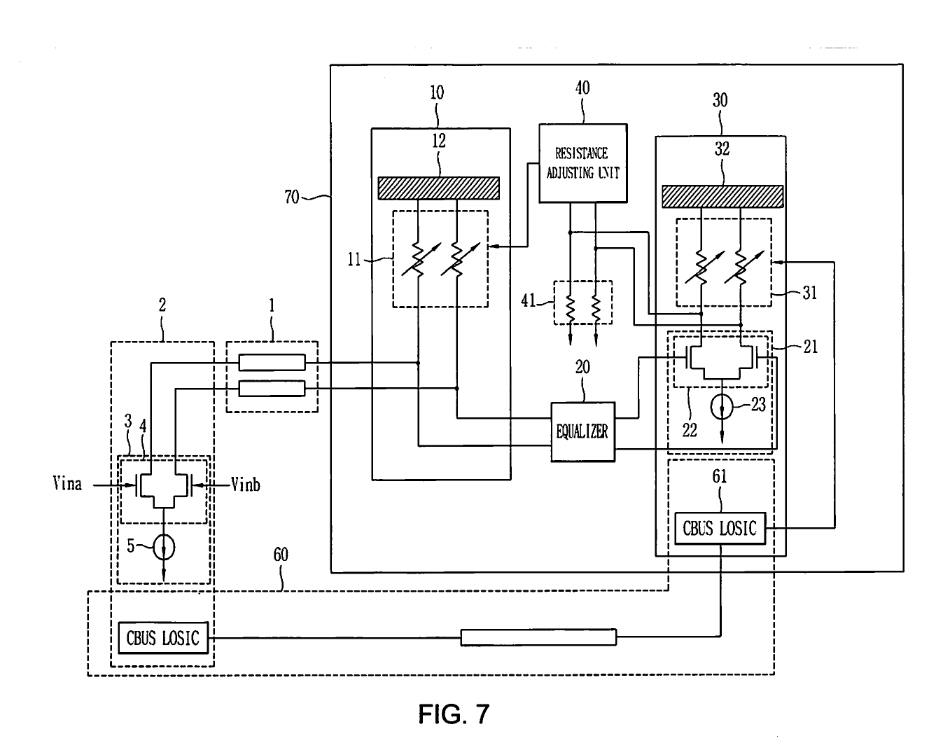

FIG. 7 is a circuit configuration diagram illustrating another exemplary embodiment of the receiving apparatus of the high speed interface system according to the present disclosure.

First, the configuration of a receiving apparatus of the high speed interface system (hereinafter, referred to as a receiving apparatus) according to the present disclosure will be described with reference to FIG. 5.

As shown in FIG. 5, the receiving apparatus 70 includes an input stage 10 provided with a first termination resistor 11 connected to a transmission cable for transmitting a signal, the input stage 10 receiving the signal; an equalizer 20 for performing equalization on the received signal; a sink circuit unit 30 provided with a second termination resistor 31, the sink circuit unit 30 receiving the equalized signal from the equalizer 20 and buffering the equalized signal; and a resistance adjusting unit 40 for detecting a reference resistance value that is a resistance value of the second termination resistor 31 and adjusting the resistance value of the first termination resistor 11 based on the detected reference resistance value.

The receiving apparatus 70 may be in the form of an IC in which a plurality of circuit elements are integrated on or in a substrate to perform a specific function.

The plurality of circuit elements mean all circuit elements that constitute an electronic circuit, such as resistors, capacitors, inductors, diodes, transistors and semiconductor elements.

The equalization means that the frequency of a received signal is adjusted. For example, the equalization may mean that the form of a signal transmitted on a circuit or cable is returned to that of the original signal by compensating for attenuation of the transmitted signal. In this case, an equalizer performs such a function.

The equalizer 20 according to the present disclosure means an equalizer for performing the equalization.

The receiving apparatus 70 is an apparatus included any one high speed interface apparatus or system, and may perform the equalization in the high speed interface apparatus or system.

For example, the receiving apparatus 70 may be configured or included in a gender, a connector, a cable port and the like, which enable signal communication between heterogeneous or homogeneous devices, to perform the equalization on a received signal.

Alternatively, the receiving apparatus 70 may be included in a signal receiving unit or central processing unit in a device, to perform the equalization on a signal received in the device.

In the receiving apparatus 70, the first and second termination resistors 11 and 31 mean termination resistors for suppressing the reflected wave of the signal.

In the receiving apparatus 70, the first and second termination resistors 11 and 31 may be variable resistors of which resistance values can be adjusted.

In the receiving apparatus 70, the resistance value of the first termination resistor 11 may be adjusted to follow the reference resistance value.

For example, when the reference resistance value is 100Ω, the resistance value of the first termination resistor 11 may be adjusted to become 100Ω.

If the resistance value of the first termination resistor 11 is adjusted to follow the reference resistance value, impedances of both the ends of a line through which the signal is transmitted/received become equal to each other, so that the attenuation and reflection of the signal are reduced.

The high speed interface system may be in the form of a differential data bus.

The differential data bus means a data transmission technique in which a signal is transmitted together in the form of a reverse signal and a non-reversed signal through two or more lines.

That is, the high speed interface system simultaneously transmits a reversed signal and a non-reversed signal.

If a differential value between the reversed signal and the non-reversed signal, received to the differential data bus, is obtained, a signal from which noise and offset included during transmission are removed can be obtained.

The high speed interface system is in the form of the differential data bus, so that the signal can be received in the form where noise and offset are removed therefrom.

The transmission cable may be in the form of the differential data bus. The transmission cable may be configured with a line through which the reversed signal is transmitted and a line through which the non-reversed signal is transmitted.

That is, the transmission cable may be configured with at least two lines.

The transmission cable may be in the form of one cable including a plurality of lines, or may be in the form of a plurality of cables corresponding to the respective lines.

The transmission cable may further include a VBUS for supplying power to the receiving apparatus 70 and a GND line.

When the VBUS and the GND line are further included in the transmission cable, the transmission cable may be configured with at least four lines.

The sink circuit unit 30 means a circuit unit to which the signal is output.

The signal may be output in the form where the signal is transmitted to another device or where the output of the signal is displayed in a series of devices.

Hereinafter, an exemplary embodiment of the receiving apparatus of the high speed interface system according to the present disclosure will be described with reference to FIG. 6.

As shown in FIG. 6, the receiving apparatus 70 includes the input stage 10 provided with the first termination resistor 11 connected to the transmission cable 1 for transmitting a signal, the input stage 10 receiving the signal; the equalizer 20 for performing equalization on the received signal; the sink circuit unit 30 provided with the second termination resistor 31, the sink circuit unit 30 receiving the equalized signal from the equalizer 20 and buffering the equalized signal; and the resistance adjusting unit 40 for detecting a reference resistance value that is a resistance value of the second termination resistor 31 and adjusting the resistance value of the first termination resistor 11 based on the detected reference resistance value. The input terminal 10 may receive the signal through the transmission cable 1 from a source circuit unit 2 for generating the signal by receiving data to be transmitted.

The source circuit unit 2 may generate the signal by receiving the data to be transmitted from another device connected thereto, and transmit the generated signal to the receiving apparatus 70 through the transmission cable 1.

The source circuit unit 2 may include a first differential amplifier 3 in which the input data to be transmitted are amplified.

The input data to be transmitted are amplifier through the first differential amplifier 3, so that the signal can be transmitted to the input stage 10 of the receiving apparatus 70.

The first differential amplifier 3 may include a pair of first switching elements 4 in the form of a differential pair, and a first bias current source 5 for driving the first switching elements 4.

The first switching element 4 may be a transistor as a semiconductor element for amplifying a signal input thereto.

The first switching element 4 may be any one of a BJT and an FET.

The first bias current source 5, as an independent current source, may supply current to an emitter or source terminal of the first switching element 4 so that the first switching element 4 can be driven.

The input stage 10 may further include a first power unit 12 that receives power for driving the equalizer 20, supplied from the outside.

That is, the first power unit 12 receives bias power of the equalizer 20, supplied from the outside, to supply the received bias power to the equalizer 20, so that the equalizer 20 can be driven.

The first power unit 12 may also receive the bias power of the equalizer 20, supplied from the VBUS.

The first power unit 12 may be connected to one end of the first termination resistor 11, and the other end of the first termination resistor 11 may be connected to the transmission cable 1 and an input terminal of the equalizer 20.

The first and second termination resistors 11 and 31 may be a pair of resistors in the form of a differential pair.

The high speed interface system is in the form of the differential data bus, so that the first and second termination resistors 11 and 31 can be in the form of the differential pair.

That is, any one of the pair of resistors is connected to the line through which the reversed signal is transmitted in the transmission cable 1, and the other of the pair of the resistors is connected to the line through which the non-reversed signal is transmitted in the transmission cable 1.

The sink circuit unit 30 may be provided with a second differential amplifier 21 in which the equalized signal is amplified, and a second power unit 32 for receiving power for driving the second differential amplifier 21 from the outside.

That is, the second power unit 32 receives bias power of the second differential amplifier 21, supplied from the outside, to supply the received the bias power to the second differential amplifier 21, so that the second differential amplifier 21 can be driven.

The second power unit 32 may also receive the bias power of the second differential amplifier 21 from the VBUS.

The second differential amplifier 21 includes a pair of second switching elements 22 in the form of a differential pair, and a second bias current source 23 for driving the second switching elements 22. The second switching element 22 may have a first terminal to which the signal is input, a second terminal connected to the second bias current source 23, and a third terminal to which the signal is amplified and output.

The second differential amplifier 21 is configured with the pair of second switching elements 22 in the form of the differential pair. That is, any one of the pair of second switching elements 22 is connected to the line through which the reversed signal is transmitted, and the other of the pair of second switching elements 22 is connected to the line through which the non-reversed signal is transmitted.

The second switching element 22 may be any one of a BJT and an FET as a semiconductor element for amplifying a signal input thereto.

When the second switching element 22 is the BJT, the first, second and third terminals may be base, emitter and collector terminals, respectively.

When the second switching element 22 is the FET, the first, second and third terminals may be gate, source and drain terminals, respectively.

The second bias current source 23, as an independent current source, may supply current to the emitter or source terminal of the second switching element 22 so that the second switching element 22 can be driven.

The first terminal may be connected to an output terminal of the equalizer 20, and the second terminal may be connected to the second bias current source 23. The third terminal may be connected to the resistance adjusting unit 40 and one end of the second termination resistor 31. The second power unit 32 may be connected to the other end of the second termination resistor 31.

That is, the equalized signal output from the equalizer 20 is input the first terminal of the second switching element 22, and the second switching element 22 is driven by the second bias current source 23 connected to the second terminal of the second switching element 22, so that the amplified signal is output from the third terminal of the second switching element 22 to be transmitted to the second termination resistor 31.

The signal amplified in the second differential amplifier 21 and transmitted to the second termination resistor 31 may be output in the form where the signal is transmitted to another device from the sink circuit unit 30 or where the output of the signal is displayed in a series of devices.

The resistance adjusting unit 40 detects the reference resistance value that is a resistance value of the second termination resistor 31 and adjusts the resistance value of the first termination resistor 11 based on the detected reference resistance value.

Hereinafter, another exemplary embodiment of the receiving apparatus of the high speed interface system according to the present disclosure will be described with reference to FIG. 7.

As shown in FIG. 7, the receiving apparatus 70 includes the input stage 10 provided with the first termination resistor 11 connected to the transmission cable 1 for transmitting a signal, the input stage 10 receiving the signal; the equalizer 20 for performing equalization on the received signal; the sink circuit unit 30 provided with the second termination resistor 31, the sink circuit unit 30 receiving the equalized signal from the equalizer 20 and buffering the equalized signal; and the resistance adjusting unit 40 for detecting a reference resistance value that is a resistance value of the second termination resistor 31 and adjusting the resistance value of the first termination resistor 11 based on the detected reference resistance value. The resistance adjusting unit 40 may include a pair of detection resistors 41 for detecting any one of voltage and current of the sink circuit unit 30.

One end of the detection resistor 41 is connected to one end of the second termination resistor 31, and the other end of the detection resistor 41 is connected to the GND line, so that the detection resistor 41 can be connected in series to the second termination resistor 31.

The resistance adjusting unit 40 detects any one of voltage and current of the sink circuit unit 30 using any one method of current calculation and voltage distribution between the detection resistor 40 and the second termination resistor 31. In this case, the resistance adjusting unit 40 may detect the resistance value of the second termination resistor 31, based on any one of the detected voltage and current.

This will be described with reference to FIG. 7. The voltages V1 and V2 shown in the detection resistors 41 of FIG. 7 may be changed depending on a ratio of resistance values of the second termination resistor 31 and the detection resistor 41. Therefore, if the voltages V1 and V2 are measured, the reference resistance value that is the resistance value of the second termination resistor 31 may be detected using an equation with respect to the voltage distribution.

The resistance adjusting unit 40 adjusts the resistance value of the first termination resistor 11 to follow the detected reference resistance value, based on the detected reference resistance value.

The resistance adjusting unit 40 may be connected to one end of the detection resistor 41 and one end of the second termination resistor 31.

That is, the detection resistor 41 and the second termination resistor 31 are branched from the resistance adjusting unit 40 to be connected to the resistance adjusting unit 40.

The high speed interface system may further include a CBUS 60 to which HPD information on the sink circuit unit 30 is transmitted.

The HPD information means a function of identifying whether the device to which the signal is to be output is to be connected to the sink circuit unit 30

The CBUS 60 may be configured with a single-ended line through which the HPD information is transmitted. In this case, a low speed control signal may be transmitted/received through the CBUS 60.

That is, the CBUS 60 is separately provided with a line through which the control signal is received and a line through which the control signal is transmitted. Therefore, the CBUS 60 may be configured with at least two lines.

The CBUS 60 may be included in the transmission cable 1, or may be separated as a separate line.

When the CBUS 60 is included in the transmission cable 1, the transmission cable 1 may be configured with at least six lines, including at least two lines in the form of the differential data bus, a voltage bus (VBUS) for supplying power to the receiving apparatus 70, a GND line, and at least two control lines of the CBUS 60.

The HPD information may be transmitted to the device to which the signal is input through the CBUS 60.

The sink circuit unit 30 may include a CBUS logic circuit 61 for performing an HPD function.

The CBUS logic circuit 61 may also be included in a circuit in which the signal is generated.

The CBUS logic circuit 61 may adjust the resistance value of the second termination resistor 31.

The CBUS logic circuit 61 may adjust the resistance value of the second termination resistor 31 depending on a kind of device connected to the sink circuit unit 30, a form and state of the signal, a state of the transmission cable 1, a state of the receiving apparatus 70, and the like.

The CBUS logic circuit 61 adjusts the resistance value of the second termination resistor 30, so that the resistance value matching with the first termination resistor 11 can be implemented in the second termination resistor 31.

### <High Speed Interface System>

A high speed interface system according to the present disclosure may be implemented using a portion or combination of components or steps included in the exemplary embodiments described above, or may be implemented using a combination of the exemplary embodiments. The technical terms used herein are used only for the purpose of illustrating a specific exemplary embodiment and do not limit the technical spirit of the present disclosure.

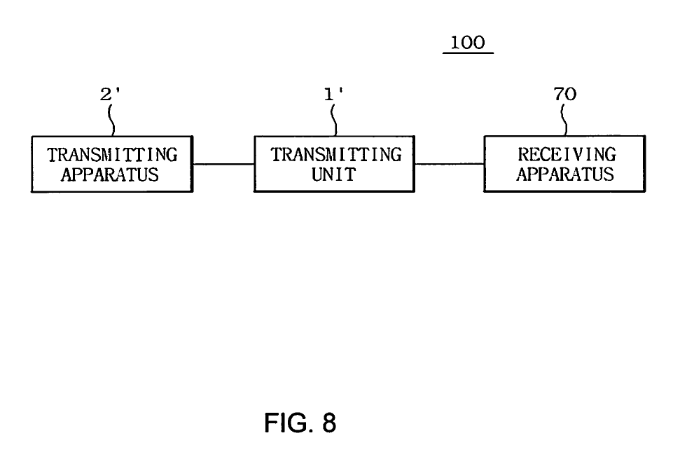

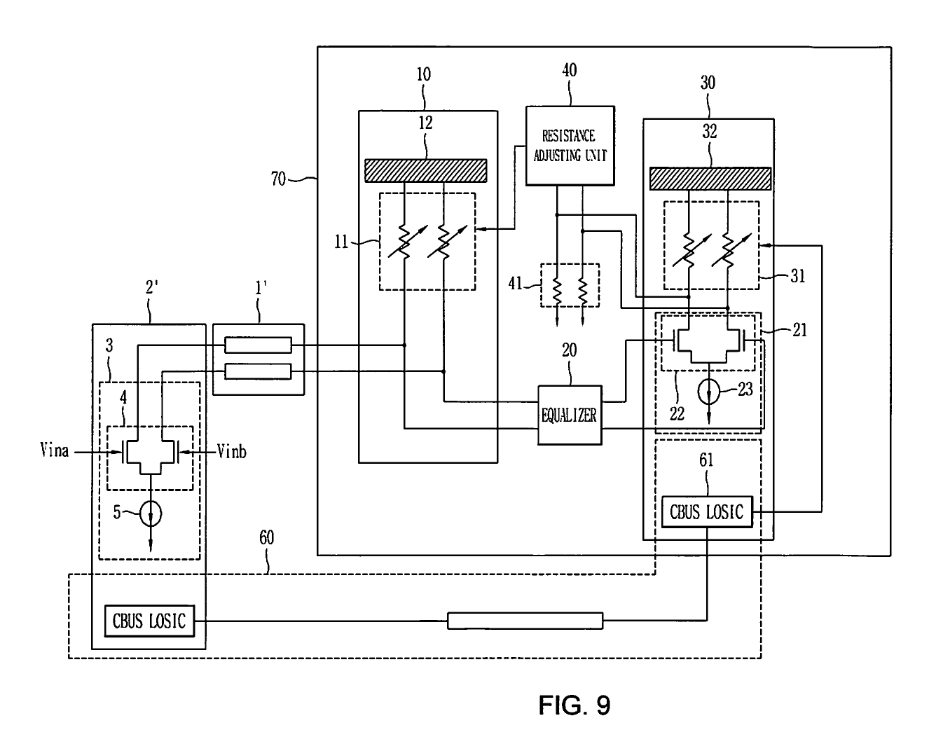

Hereinafter, an exemplary embodiment of a high speed interface system (hereinafter, referred to as a system) according to the present disclosure will be described with reference to FIGS. 8 and 9.

FIG. 8 is a configuration diagram illustrating the high speed interface system according to the present disclosure.

FIG. 9 is a circuit configuration diagram illustrating an exemplary embodiment of the high speed interface system according to the present disclosure.

As shown in FIG. 8, the system 100 includes a transmitting apparatus 2′ for generating a signal by receiving data to be transmitted, a transmitting unit 1′ for transmitting the signal to a receiving apparatus 70 from the transmitting apparatus 2′, and the receiving apparatus 70 for receiving the signal.

The system 100 also includes the transmitting apparatus 2′ and the receiving apparatus 70. In this case, the transmitting apparatus 2′ may include the transmitting unit 1′.

As shown in FIG. 9, the system 100 includes the transmitting apparatus 2′, the transmitting unit 1′ and the receiving apparatus 70. The receiving apparatus 70 includes an input unit 10 provided with a first termination resistor 11 connected to the transmitting unit 1′, the input unit 10 receiving the signal; an equalizer for performing equalization on the received signal; a sink circuit unit 30 provided with a second termination resistor 31, the sink circuit unit 30 receiving the equalized signal from the equalizer 20 and buffering the equalized signal; and a resistance adjusting unit 40 for detecting a reference resistance value that is a resistance value of the second termination resistor 31 and adjusting the resistance value of the first termination resistor 11 based on the detected reference resistance value.

In the system 100, the resistance value of the first termination resistor 11 may be adjusted to follow the reference resistance value.

The system 100 may be in the form of a differential data bus.

The first and second termination resistors 11 and 31 may be a pair of resistors in the form of a differential pair.

The transmitting unit 1′ may be a transmission cable.

The transmitting unit 1′ may be in the form of the differential data bus. The transmitting unit 1′ may be configured with a line through which the reversed signal is transmitted and a line through which the non-reversed signal is transmitted.

That is, the transmitting unit 1′ may be configured with at least two lines.

The transmitting unit 1′ may be in the form of one cable including a plurality of lines, or may be in the form of a plurality of cables corresponding to the respective lines.

The transmitting unit 1′ may further include a VBUS for supplying power to the receiving apparatus 70 and a GND line.

The transmitting apparatus 2′ may generate the signal by receiving the data to be transmitted from another device connected thereto, and transmit the generated signal to the receiving apparatus 70 through the transmitting unit 1′.

The transmitting apparatus 2′ may include a first differential amplifier 3 in which the input data to be transmitted are amplified.

The input data to be transmitted are amplifier through the first differential amplifier 3, so that the signal can be transmitted to the input stage 10 of the receiving apparatus 70.

The first differential amplifier 3 may include a pair of first switching elements 4 in the form of a differential pair, and a first bias current source 5 for driving the first switching elements 4.

The first switching element 4 may be a transistor as a semiconductor element for amplifying a signal input thereto.

The first switching element 4 may be any one of a BJT and an FET.

The first bias current source 5, as an independent current source, may supply current to an emitter or source terminal of the first switching element 4 so that the first switching element 4 can be driven.

The input stage 10 may further include a first power unit 12 that receives power for driving the equalizer 20, supplied from the outside.

That is, the first power unit 12 receives bias power of the equalizer 20, supplied from the outside, to supply the received bias power to the equalizer 20, so that the equalizer 20 can be driven.

The first power unit 12 may also receive the bias power of the equalizer 20, supplied from the VBUS.

The first power unit 12 may be connected to one end of the first termination resistor 11, and the other end of the first termination resistor 11 may be connected to the transmission cable 1 and an input terminal of the equalizer 20.

The system 100 is in the form of the differential data bus, so that the first and second termination resistors 11 and 31 can be in the form of the differential pair.

The sink circuit unit 30 may be provided with a second differential amplifier 21 in which the equalized signal is amplified, and a second power unit 32 for receiving power for driving the second differential amplifier 21 from the outside.

The second power unit 32 may also receive the bias power of the second differential amplifier 21 from the VBUS.

The second differential amplifier 21 includes a pair of second switching elements 22 in the form of a differential pair, and a second bias current source 23 for driving the second switching elements 22. The second switching element 22 may have a first terminal to which the signal is input, a second terminal connected to the second bias current source 23, and a third terminal to which the signal is amplified and output.

The second switching element 22 may be any one of a BJT and an FET as a semiconductor element for amplifying a signal input thereto.

When the second switching element 22 is the BJT, the first, second and third terminals may be base, emitter and collector terminals, respectively.

When the second switching element 22 is the FET, the first, second and third terminals may be gate, source and drain terminals, respectively.

The second bias current source 23, as an independent current source, may supply current to the emitter or source terminal of the second switching element 22 so that the second switching element 22 can be driven.

The first terminal may be connected to an output terminal of the equalizer 20, and the second terminal may be connected to the second bias current source 23. The third terminal may be connected to the resistance adjusting unit 40 and one end of the second termination resistor 31. The second power unit 32 may be connected to the other end of the second termination resistor 31.

That is, the equalized signal output from the equalizer 20 is input the first terminal of the second switching element 22, and the second switching element 22 is driven by the second bias current source 23 connected to the second terminal of the second switching element 22, so that the amplified signal is output from the third terminal of the second switching element 22 to be transmitted to the second termination resistor 31.

The resistance adjusting unit 40 detects the reference resistance value that is a resistance value of the second termination resistor 31 and adjusts the resistance value of the first termination resistor 11 based on the detected reference resistance value, so that the signal can be transmitted to the sink circuit unit 30 in a state in which the attenuation and reflection of the signal are reduced.

The resistance adjusting unit 40 may include a pair of detection resistors 41 for detecting any one of voltage and current of the sink circuit unit 30.

One end of the detection resistor 41 is connected to one end of the second termination resistor 31, and the other end of the detection resistor 41 is connected to the GND line, so that the detection resistor 41 can be connected in series to the second termination resistor 31.

The resistance adjusting unit 40 detects any one of voltage and current of the sink circuit unit 30 using any one method of current calculation and voltage distribution between the detection resistor 40 and the second termination resistor 31. In this case, the resistance adjusting unit 40 may detect the resistance value of the second termination resistor 31, based on any one of the detected voltage and current.

The resistance adjusting unit 40 adjusts the resistance value of the first termination resistor 11 to follow the detected reference resistance value, based on the detected reference resistance value.

The resistance adjusting unit 40 may be connected to one end of the detection resistor 41 and one end of the second termination resistor 31.

The system 100 may further include a CBUS 60 to which HPD information on the sink circuit unit 30 is transmitted.

The CBUS 60 may be configured with a single-ended line through which the HPD information is transmitted. In this case, a low speed control signal may be transmitted/received through the CBUS 60.

The CBUS 60 may be included in the transmitting unit 1′, or may be separated as a separate line.

The HPD information may be transmitted to the device to which the signal is input through the CBUS 60.

The sink circuit unit 30 may include a CBUS logic circuit 61 for performing an HPD function.

The CBUS logic circuit 61 may also be included in a circuit in which the signal is generated.

The CBUS logic circuit 61 may adjust the resistance value of the second termination resistor 31.

The CBUS logic circuit 61 may adjust the resistance value of the second termination resistor 31 depending on a kind of device connected to the sink circuit unit 30, a form and state of the signal, a state of the transmitting unit 1′, a state of the receiving apparatus 70, and the like.

The apparatus of the high speed interface system and the high speed interface system according to the present disclosure can be applied and implemented in an apparatus and a system for high speed interface.

The apparatus of the high speed interface system and the high speed interface system according to the present disclosure can be applied and implemented in an IC and an equalizing circuit for high speed interface.

The apparatus of the high speed interface system and the high speed interface system according to the present disclosure can be applied and implemented in a gender, a connector, a cable port and the like, which enable signal communication between heterogeneous or homogeneous devices.

The apparatus of the high speed interface system and the high speed interface system according to the present disclosure can be applied and implemented in an MHL, a DVI, an HDMI and the like.

In the apparatus of the high speed interface system and the high speed interface system according to the present disclosure, the resistance value of a termination resistor in a circuit for high speed interface is adjusted to follow that of the termination resistor of the sink circuit unit, so that it is possible to implement efficient equalization and high speed interface.

In the apparatus of the high speed interface system and the high speed interface system according to the present disclosure, the CBUS is not built in the equalizer IC, so that the configuration of the high speed interface system can be simplified.

In the apparatus of the high speed interface system and the high speed interface system according to the present disclosure, the resistance value of the termination resistor is adjusted without building the CBUS in the equalizer IC, so that it is possible to improve the performance and efficiency of the high speed interface system.

In the apparatus of the high speed interface system and the high speed interface system according to the present disclosure, efficient equalization is implemented while simplifying the configuration of the high speed interface system, so that the thickness of a data transmission cable can be maintained thin.

In the apparatus of the high speed interface system and the high speed interface system according to the present disclosure, the thickness of the data transmission cable is maintained thin, so that it is possible to suppress loss and attenuation of signals.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. An equalizer module of a high speed interface system, comprising:
an input stage provided with a first termination resistor connected to a transmission cable for transmitting a signal, the input stage receiving the signal;
an equalizer configured to perform equalization on the received signal; and
a resistance adjusting unit connected to a sink circuit unit for receiving the equalized signal from the equalizer and buffering the equalized signal, to detect a reference resistance value that is a resistance value of a second termination resistor provided in the sink circuit unit and adjust the resistance value of the first termination resistor based on the detected reference resistance value.

2. The equalizer module of claim 1, wherein the resistance value of the first termination resistor is adjusted to follow the reference resistance value.

3. The equalizer module of claim 2, wherein the high speed interface system is in the form of a differential data bus, and
wherein the first and second termination resistors are a pair of resistors in the form of a differential pair.

4. The equalizer module of claim 3, wherein the input stage further includes a first power unit configured to receive the signal through the transmission cable from a source circuit unit for generating the signal by receiving data to be transmitted and receive power for driving the equalizer, supplied from the outside.

5. The equalizer module of claim 4, wherein the first power unit is connected to one end of the first termination resistor, and
wherein the other end of the first termination resistor is connected to the transmission cable and an input terminal of the equalizer.

6. The equalizer module of claim 3, wherein the equalizer is provided with a second differential amplifier in which the equalized signal is amplified, and
wherein the second differential amplifier is driven by receiving power supplied from a second power unit provided in the sink circuit unit.

7. The equalizer module of claim 6, wherein the second differential amplifier includes:
a pair of second switching elements in the form of the differential pair; and
a second bias current source configured to drive the second switching elements,
wherein the second switching element includes:
a first terminal to which the signal is input;
a second terminal to which the second bias current source is connected; and
a third terminal to which the signal is amplified and output.

8. The equalizer module of claim 7, wherein the first terminal is connected to an output terminal of the equalizer,
wherein the second terminal is connected to the second bias current source, and
wherein the third terminal is connected to the resistance adjusting unit and one end of the second termination resistor.

9. The equalizer module of claim 3, wherein the resistance adjusting unit includes a pair of detection resistors configured to detect any one of voltage and current of the sink circuit unit.

10. The equalizer module of claim 9, wherein the resistance adjusting unit detects any one of voltage and current of the sink circuit unit using any one method of current calculation and voltage distribution between the detection resistor and the second termination resistor, and
wherein the resistance adjusting unit detects the resistance value of the second termination resistor, based on any one of the detected voltage and current.

11. The equalizer module of claim 10, wherein the resistance adjusting unit is connected to one end of the detection resistor and the one end of the second termination resistor.

12. The equalizer module of claim 3, wherein the high speed interface system further includes a command bus (CBUS) to which hot plug detection (HPD) information on the sink circuit unit is transmitted.

13. The equalizer module of claim 12, wherein the sink circuit unit includes a CBUS logic circuit configured to perform an HPD function, and
wherein the CBUS logic circuit adjusts the resistance value of the second termination resistor.

14. A high speed interface system, comprising:
a transmitting apparatus configured to generate a signal by receiving data to be transmitted;
a transmitting unit configured to transmit the signal from the transmitting apparatus to a receiving apparatus; and
the receiving apparatus configured to receive the signal,
wherein the receiving apparatus includes:
an input unit provided with a first termination resistor connected to the transmitting unit, the input unit receiving the signal;
an equalizer configured to perform equalization on the received signal;
a sink circuit unit provided with a second termination resistor, the sink circuit unit receiving the equalized signal from the equalizer and buffering the equalized signal; and
a resistance adjusting unit configured to detect a reference resistance value that is a resistance value of the second termination resistor and adjust the resistance value of the first termination resistor based on the detected reference resistance value.

15. The high speed interface system of claim 14, wherein the resistance value of the first termination resistor is adjusted to follow the reference resistance value.

16. The high speed interface system of claim 15, wherein the high speed interface system is in the form of a differential data bus, and
wherein the first and second termination resistors are a pair of resistors in the form of a differential pair.

17. The high speed interface system of claim 16, wherein the resistance adjusting unit includes a pair of detection resistors configured to detect any one of voltage and current of the sink circuit unit,
wherein the resistance adjusting unit detects any one of voltage and current of the sink circuit unit using any one method of current calculation and voltage distribution between the detection resistor and the second termination resistor, and
wherein the resistance adjusting unit detects the resistance value of the second termination resistor, based on any one of the detected voltage and current.

18. The high speed interface system of any one of claims 14 to 17, further comprising a CBUS to which HPD information on the sink circuit unit is transmitted.
